(19) United States
(12) Patent Application Publication
(10) Pub. No.: US 2007/0068621 A1
(43) Pub. Date: Mar. 29, 2007

(54) Manufacturing process by the use of warm lamination method to adhere to IC card having multi electronic components

(76) Inventors: Chi-Yuan Ou, Taipei (TW); Bing-Je Lee, Taipei (TW)

Correspondence Address: LOWE HAUPTMAN BERNER, LLP, 1700 DIAGONAL ROAD, SUITE 300, ALEXANDRIA, VA, 22314, US

(21) Appl. No.: 11/236,583

(22) Filed: Sep. 28, 2005

(51) Int. Cl. B32B 37/12; B32B 38/04

(52) U.S. Cl. 156/252; 156/256

(57) ABSTRACT

A manufacturing process of the invention by the use of warm lamination methodto adhere to an IC card having multi electronic componentsis disclosed. The invention mainly intends to prevent the built-in multi electronic components of the IC card from being damaged during the thermal pressing process. In the meantime, the invention can improve yield as well as complete the adhesion of the IC card under the condition having using only the IC card's pressing facility already have that can conform the conditions of the present manufacturing process without affecting the capacity of the production scale. The steps of the manufacturing process are as follows. (I). printing beforehand the upper layer and lower layer of the main body into the required panel in accordance with demands. (II). depending on the requirements, milling hole beforehand for the upper layer of the IC card's main body in accordance with the relative location of the multi electronic components of the built-in IC chip etc. of the central filling layer. (III). applying beforehand coating with glue on the adhesion surface portion between the upper and lower layers of the IC card's main body. (IV). pressing and heating the layers of the IC cards by the use of the plate of the layer pressing machine up to a temperature between 50-80° C. and a pressure between 2-8 mpa (mega pascal) to make the upper, lower, and central layers adhere together. (V). after finishing pressing and adhering, taking the IC card's main body out from the pressing machine, and performing punching and cutting into the required size of IC cards so as to complete the manufacturing of an IC card having multi electronic components.

### FIELD OF THE INVENTION

The invention relates to a manufacturing process of an IC card having multi electronic components, and more particularly, relates to a manufacturing process by the use of warm lamination method to adhere to IC card having multi electronic components.

### BACKGROUND OF THE INVENTION

Owing to the progress in technology, a lot of business transactions and the ways of disbursement have been gradually replaced by magnetic cards made of plastics or IC cards such as credit cards, financial cards, telephone cards, health insurance cards, bus cards, or rapid transit system saving cards etc. Among the category of IC cards, there is a kind of intelligent IC card having electronic component. This IC card does not only have saving and memorizing functions, it has the functions of displaying data, buzzing and displaying warning light as well. This kind of IC card will soon become the most circulating transaction medium among the business transaction platforms in the future. On the contrary, since the functions of the conventional magnetic cards cannot meet the contemporary demands, they are eliminated gradually. Consequently, the number of IC cards being circulated is getting higher and higher and outnumber those of the conventional magnetic card.

The above-mentioned IC cards currently circulated on the market include contact-type interface, contactless type interface, or combi smartcards or memory cards. However, no matter what type of IC card it belongs to, its basic structure includes three layers of main body. That is, an upper and a lower layers mainly made of PVC plastics and are able to be printed, as well as a bearing sheet or a central filling layer of the substrate made of PVC plastics for placing the electronic component, such as IC chip. The hot lamination method is, by the high temperature pressing method, to use high temperature to make the PVC plastics of the upper, lower layers as well as the central filling layer melt together. Afterwards, the manufacturing of the IC cards is performed by punching them, milling holes, and embedding the IC chip.

A brief description, accompanied by drawings, of the manufacturing process of the IC cards by the use of hot lamination methodof the currently circulated IC cards is shown as follows

[symbol]

1. The main body (1) of a common IC card as shown in FIG. 1(a) 20 includes an upper layer (11), a lower layer (13), and a central filling layer (12) which are mainly made of plastics. Among them, the upper and lower layers can be printed beforehand depending on the requirements, while the central filling layer is a bearing sheet or a substrate for placing the electronic component, such as IC chip, but not having them placed on yet.

2. By the use of thermal-layer pressing machine, having its temperature control set at least at 130° C., the plastics of the upper, central, and lower layers of the main body are melted together by the high temperature and then pressed to become plastic cards without electronic component.

3. The plastic cards completed by the step 2 are milled holes according to the size of the electronic component, such as IC chip to be embedded, and then punched and cut to complete the IC card (2) manufacturing as shown in FIG. 1(b).

The manufacturing process as referring to the flow chart in FIG. 2 of the above-mentioned hot lamination methodhas the following advantages. By the use of the general hot lamination machine, the facility and technique are available to all, and the number of layers to be pressed can be as high as 48 layers depending on the specification of the facility. Its capacity is quite high as the highest quantity of pressing is 24 pieces.

However, the manufacturing process according to the hot lamination methodhas the following disadvantages. The temperature used by the hot lamination method for melting is relatively higher. Besides, the time required for a single press from heating to maintain a temperature to lowering temperature again is around 30˜90 minutes altogether. Therefore, the method obviously consumes relatively higher power, thereby, wastes more energy and is unable to lower the manufacturing cost, and indirectly affect the capacity of production. What is more, the process of milling and embedding electronic component, such as IC chip etc. after thermal pressing is apt to cause the electronic component, such as IC chip etc. to come of. This will indirectly cause inconvenience for the users. Furthermore, if the holes are not milled in appropriate manner, this will result in the fact that the card cannot sustain the electronic component, such as IC chip etc. Consequently, the cards will be scrapped and will become waste of material and will make the high cost of manufacturing. What is more, the embedding process of electronic component, such as IC chip etc. is limited to those small in size and simple in function, thereby the function of the IC cards is unable to improve.

In the light of the foregoing drawbacks of “the manufacturing process by the use of hot lamination method for manufacturing IC card having multi electronic components, the inventor found out that the conventional manufacturing process is hard to apply in manufacturing the multifunctional intelligent type of IC card while embodying his other invention—“KEY PRESSING OR DISPLAY TYPE MULTIFUNCTIONAL INTELLIGENT IC CARD”. Therefore, the inventor develops a manufacturing process of the invention that can not only overcome drawbacks of the conventional manufacturing process but can embody the above-mentioned invention—“KEY PRESSING OR DISPLAY TYPE MULTIFUNCTIONAL INTELLIGENT IC CARD” as well. It can further provide multifunctional requirements and convenience too.

### SUMMARY OF THE INVENTION

In view of the above-mentioned disadvantages of the prior arts, the invention provides a manufacturing process making use of warm lamination method to adhere to an IC card having multi electronic componentsthat aims to ameliorate at least some of the disadvantages of the prior art or to provide a useful alternative.

Therefore, in order to compensate the above-mentioned imperfection of the prior art, one of the objectives of the invention is to make the multifunctional intelligent type of IC card or multifunctional intelligent type of IC card having multi electronic componentssuch as key pressing or display type embody or produce in large scale and further provide multifunctional requirements and convenience.

It is another objective of the invention to provide a manufacturing process that can protect the preset IC chip or electronic component of key pressing type or display type of the central filling layer from being damaged due to overheating or over-pressing, and in the meantime improve yield and capacity.

To achieve the above-mentioned objectives, the invention provides a manufacturing process of the invention by the use of warm lamination method to adhere to an IC card having multi electronic components. The steps of the manufacturing process are as follows. (I). printing beforehand the upper layer and lower layer of the main body into the required panel in accordance with demands. (II). depending on the requirements, milling hole beforehand for the upper layer of the IC card's main body in accordance with the relative location of the multi electronic componentsof the built-in IC chip etc. of the central filling layer. (III). applying beforehand coating with glue on the adhesion surface portion between the upper and lower layers of the IC card's main body. (IV). pressing and heating the layers of the IC cards by the use of the plate of the layer pressing machine up to a temperature between 50˜80° C. and a pressure between 2˜8 mpa (mega pascal) to make the upper, lower, and central layers adhere together. (V). after finishing pressing and adhering, taking the IC card's main body out from the pressing machine, and performing punching and cutting into the required size of IC cards so as to complete the manufacturing of an IC card having multi electronic components.

In the manufacturing process of the invention, the facility used for pressing is a thermal-layer pressing machine having temperature-controlled apparatus utilizing a plate heated to a temperature at 60˜80° C. and with pressure set at 2˜8 mpa (mega pascal) (1 mpa=10.1972 Kgf/cm², which is generally called as engineering atmospheric pressure) as the optimum state. Based on this manufacturing process condition, the multi electronic components, such as IC chip or key-press or display panel preset in the central filling layer can be prevented from being damaged due to the overheated or over-pressed conditions. Furthermore, in general, the platform of the thermal-layer pressing machine has a certain available fixed area, thus the user has the card's main body (upper, lower, and central filling layers) intended to be pressed cut beforehand in accordance with the area to become the maximum area that is able to place. After they are pressed and adhered, one can perform punching and cutting to meet the required size of the card. Of cause, the number of electronic component in the central filling layer is counted and placed beforehand. In addition, as far as the manufacturing process of the invention is concerned, the maximum number of layer capable to press can be as high as 10 or more counting by the upper and lower layers depending on the facility or relevant apparatus. Therefore, it goes without saying that the capacity of production is quite high. What is more, a single pressing time based on the manufacturing process of the invention needs only 3˜5 minutes while the manufacturing process of the “hot lamination method” requires 30˜60 minutes. Therefore, virtually the invention can save significant amount of power. Besides, the invention can shorten the manufacturing process which does not only increase the capacity of production, it lower some manufacturing cost as well. In other sense, as far as the required temperature of the manufacturing process is concerned, the highest temperature needed is only 80° C., thereby, its power consuming is not as high as that of the manufacturing process of the “hot lamination method”. Consequently, the invention can certainly save some energy and lower the manufacturing cost.

According the above-mentioned description, one can summarize the steps of the manufacturing process of the invention as follow [symbol]
(I) Printing beforehand the upper layer and lower layer made of PVC, or PET, or PC material of the main body into the required panel in accordance with demands; and, depending on the requirements, milling hole beforehand for the upper layer of the IC card's main body in accordance with the relative location of the multi electronic components of the IC chip etc. of the central filling layer.
(II) Placing beforehand the IC chip etc. of multi electronic componentsin the central filling layer made of PVC, or PET, or PC material.
(III) Applying beforehand coating with glue (mainly made of pressure-sensitive type, thermal-setting type or thermal-plastic type etc.) on the adhesion surface portion between the upper and lower layers of the IC card's main body.
(IV) Aligning the relative locations of the upper, lower, and central layers of the IC card's main body, and placing the IC card's main body on the platform of the thermal-layer pressing machine depending on the required number of layer.
(V) Pressing the upper, lower, and central layers of the IC card's main body to make the upper, lower, and central layers of the IC card's main body adhere together by the use of the glue under the condition that the plate of the temperature-controlled apparatus of the thermal-layer pressing machine is heated to a temperature between 50˜80° C. and the pressure is set between 2˜8 mpa (mega pascal).
(VI) After finishing pressing and adhering, taking the IC card's main body having multi electronic components out from the platform of pressing apparatus of the thermal-layer pressing machine, and performing punching and cutting to the required size of IC cards, so as to complete the manufacturing of IC cards having multi electronic components.

Detailed description as well as the content of the techniques that relate to the invention accompanied by the drawings is described in the following:

### BRIEF DESCRIPTION OF THE DRAWINGS

FIG. 1(a) is an exploded view of the IC card's main body of the prior art.

FIG. 1(b) is a schematic diagram of the IC card's finished product of the prior art.

FIG. 2 is a flow chart of the embodiment of the prior art.

FIG. 3(a) is an exploded view of the IC card's main body of the invention.

FIG. 3(b) is a schematic diagram of the IC card's finished product of the invention.

FIG. 4 is a flow chart of the first embodiment of the invention.

FIG. 5 is a flow chart of the second embodiment of the invention.

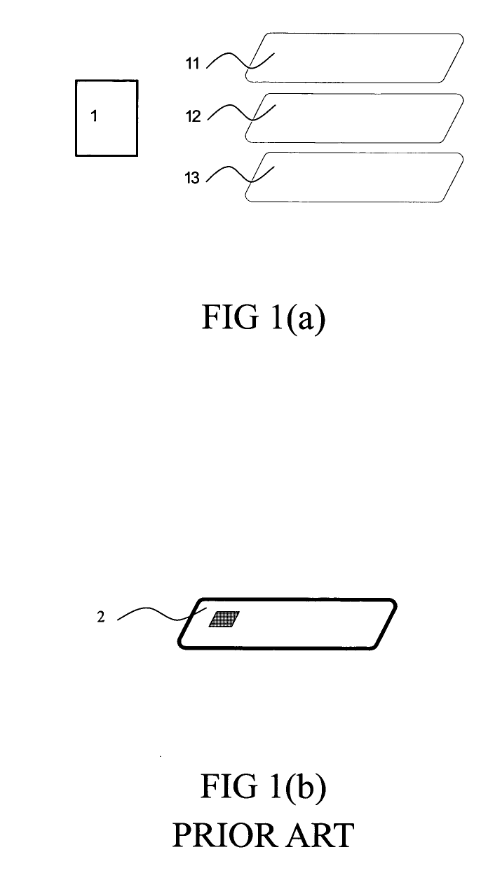

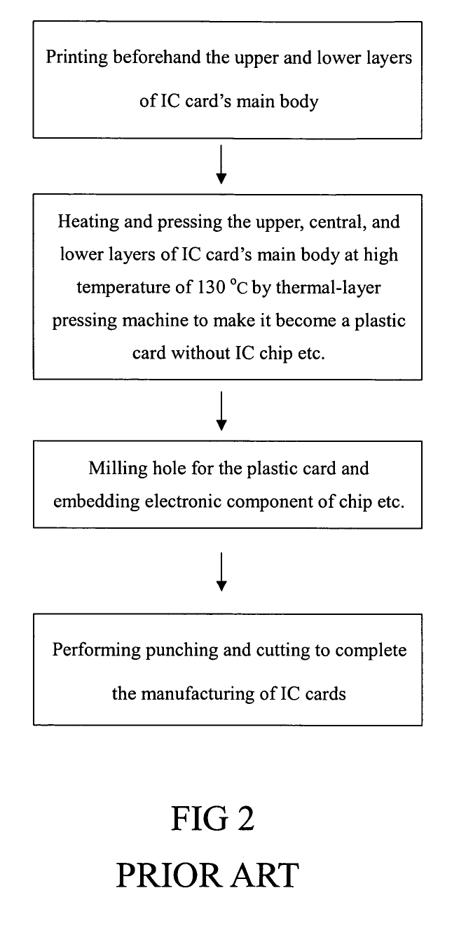

### DETAILED DESCRIPTION OF THE EMBODIMENTS

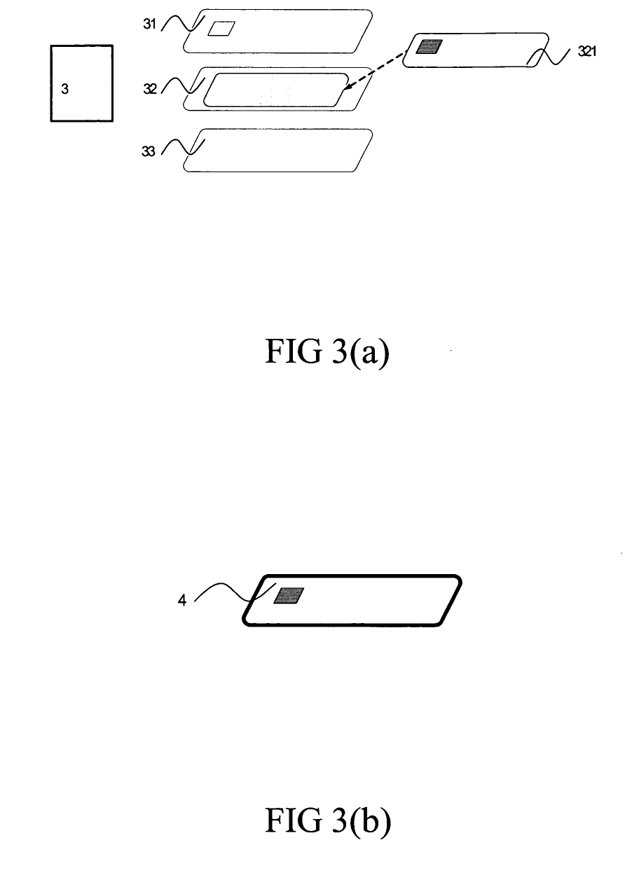

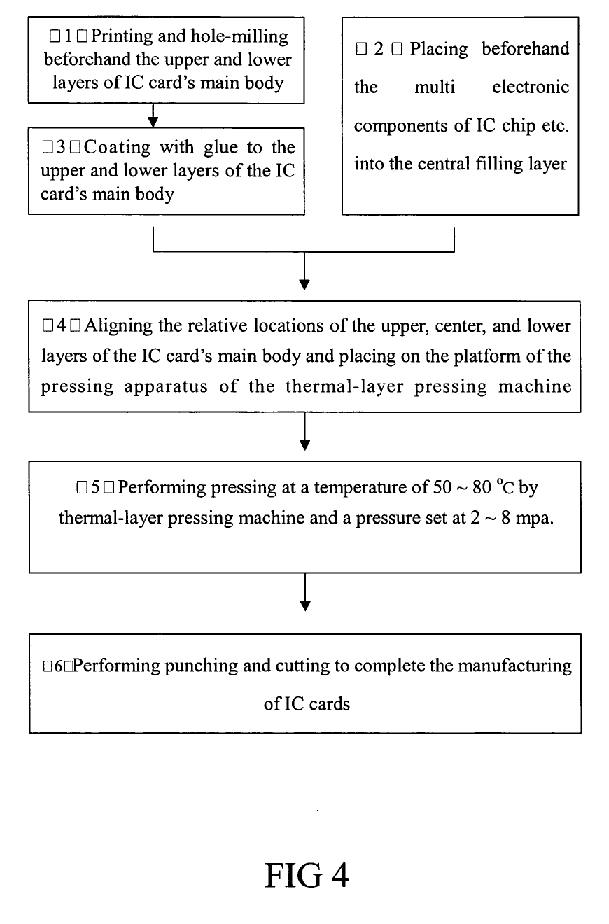

FIG. 3(a) is an exploded view of the IC card's main body of the invention and FIG. 4 is a flow chart of the first embodiment of the invention. As shown in 3(a) and FIG. 4, the steps of the manufacturing process of the invention are as follows [symbol]
(I) Printing beforehand the upper layer (31) and lower layer (33) made of PVC, or PET, or PC material of the main body (3) into the required panel in accordance with demands; and, depending on the requirements, milling hole beforehand for the upper layer of the IC card's main body in accordance with the relative location of the multi electronic components of the IC chip etc. of the central filling layer.
(II) Placing beforehand the IC chip or key-pressing type or display device etc. of the multi electronic components (321) in the central filling layer (32).
(III) Applying beforehand coating with glue on the adhesion surface portion between the upper and lower layers of the IC card's main body
(IV) Aligning the relative locations of the upper, lower, and central layers of the IC card's main body, and placing the IC card's main body on the platform of the thermal-layer pressing machine depending on the required number of layer.
(V) Pressing the upper, lower, and central layers of the IC card's main body to make the upper, lower, and central layers of the IC card's main body adhere together wherein the temperature is controlled between 50˜80° C. and the pressure is set between 2˜8 mpa (mega pascal).
(VI) After finishing pressing and adhering, taking the IC card's main body having multi electronic components out from the platform of pressing apparatus of the thermal-layer pressing machine, and performing punching and cutting to the required size of IC cards, so as to complete the manufacturing of IC cards (4) having multi electronic componentsas shown in FIG. 3(b).

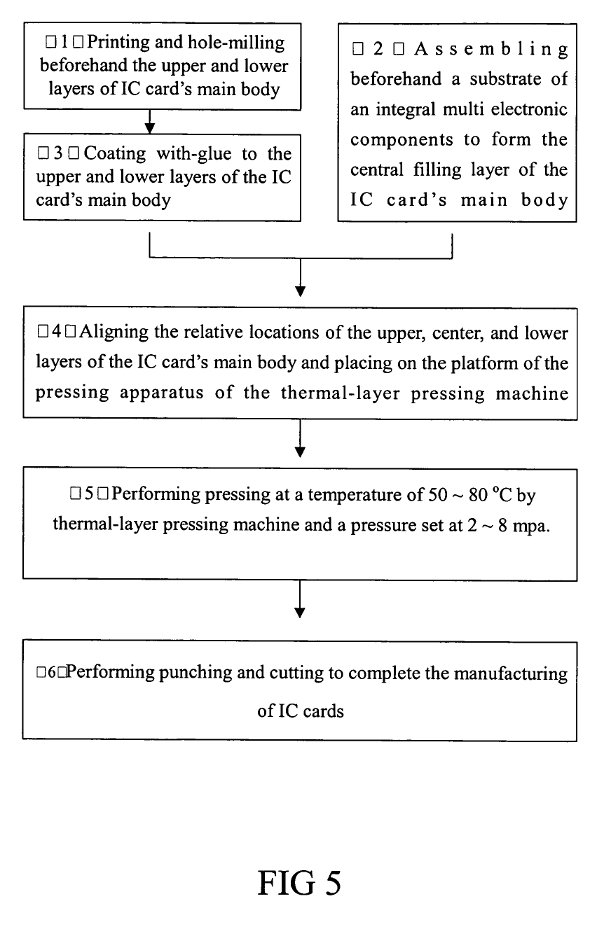

FIG. 5 is a flow chart of the second embodiment of the invention. As shown in FIG. 5, the steps of the manufacturing process are all the same as those of the first embodiment except that step II of the second embodiment is slightly different from that of the first embodiment. In step II of this second embodiment, the central filling layer utilizes an integral substrate of multi electronic componentsthat is assembled beforehand.

By the use of the above-mentioned two embodiments of the invention, the drawbacks of the IC cards having multi electronic components utilizing the hot lamination manufacturing processof thermal pressing method can be improved. In the meantime, it can protect the preset IC chip or multi electronic components of key pressing type or display type of the central filling layer from being damaged due to overheating or over-pressing, and in the meantime improve yield and capacity of production. Consequently, it can lower the cost of the IC cards having multi electronic components to achieve the object of energy saving. In addition, it can make the multifunctional intelligent IC cards having multi electronic componentssuch as key-pressing or display type embody and produce in large scale. It can further provide business transactions and convenience to meet multifunctional requirements that make the invention practical and having industrial utility.

It will become apparent that for those people skilled in the art can make various modifications and variations that can be made to the structure of the invention without departing from the scope or spirit of the invention. In view of the foregoing, it is intended that all the modification and variation fall within the scope of the following appended claims and their equivalents.

What is claimed is:

1. A manufacturing process by the use of warm lamination method to adhere to an IC card having multi electronic components, comprising the following steps:
(I) Printing beforehand an upper layer and lower layer of an IC card's main body into a required panel in accordance with demands;
(II) Milling hole beforehand for the upper layer of the IC card's main body in accordance with the relative location of the multi electronic components of IC chip etc. of a central filling layer;
(III) Placing beforehand the central filling layer of the IC card's main body into the multi electronic components,such as IC chip etc.;
(IV) Applying beforehand coating with glue on the adhesion surface portion between the upper and lower layers of the IC card's main body; and
(V) Aligning the relative locations of the upper, lower, and central filling layers of the IC card's main body, and placing the IC card's main body on the platform of the thermal-layer pressing machine depending on the required number of layer, and heating the plate of the temperature controlled apparatus of the thermal layer pressing machine to a temperature between 50˜80° C., then pressing the upper, lower, and central layers of the IC card's main body to make the upper, lower, and central layers of the IC card's main body adhere together.

2. The manufacturing process by the use of warm lamination method to adhere to an IC card having multi electronic components as claimed in claim 1, wherein the upper, lower, and central filling layers of the formed main body of the IC card to be manufactured are made of PVC material.

3. The manufacturing process by the use of warm lamination method to adhere to an IC card having multi electronic components as claimed in claim 1, wherein the upper, lower, and central filling layers of the formed main body of the IC card to be manufactured are made of PET material.

4. The manufacturing process by the use of warm lamination method to adhere to an IC card having multi electronic components as claimed in claim 1, wherein the upper, lower, and central filling layers of the formed main body of the IC card to be manufactured are made of PC material.

5. The manufacturing process by the use of warm lamination method to adhere to an IC card having multi electronic components as claimed in claim 1, wherein the central filling layer of the IC card's main body having multi electronic componentsis an integral substrate of multi electronic componentsthat is assembled beforehand.

6. The manufacturing process by the use of warm lamination method to adhere to an IC card having multi electronic components as claimed in claim 1, wherein the pressure is set between 2˜8 mpa when the upper and lower layers as well as the central filling layer of the IC card's main body is pressed.
